(19) United States
(12) Patent Application Publication
(10) Pub. No.: US 2004/0137124 A1
(43) Pub. Date: Jul. 15, 2004

(54) Preparation and use of potato chlorogenic acid

(76) Inventors: Jean Tricoit, Soisson (FR); Gerard Rousset, Wissous (FR)

Correspondence Address: Welsh & Katz, Ltd., Eric D. Cohen, 22nd Floor, 120 South Riverside Plaza, Chicago, IL, 60606, US

(21) Appl. No.: 10/676,981

(22) Filed: Oct. 1, 2003

Related U.S. Application Data
(63) Continuation-in-part of application No. 10/366,882, filed on Feb. 14, 2003.

(30) Foreign Application Priority Data
Oct. 2, 2002 (FR) 02 12203

(51) Int. Cl. A23B 4/00

(52) U.S. Cl. 426/544

(57) ABSTRACT

This invention relates to a method for preparing chlorogenic acid from potatoes and the use of chlorogenic acid to prevent or inhibit browning reactions in potatoes after cooking, in particular dehydrated potato flakes.

The present invention relates to the preparation and use of chlorogenic acid for preventing the browning of potatoes after cooking. In accordance with the present invention, chlorogenic acid is more particularly used as antioxidant in the manufacture of dehydrated potato flakes.

It is well known that most foodstuffs such as fruits and vegetables, in particular potatoes, have a tendency to brown during prolonged periods of storage. This phenomenon is often called “browning reaction”. Although the browned product is not toxic and has not lost its nutritional value, this coloration nevertheless gives it an appearance and a taste which are not very attractive for the consumer. The causes of these browning reactions have been the subject of a considerable number of studies and it is now established that an enzymatic reaction is mainly responsible for the phenomenon.

The enzymatic browning of vegetables results from the oxidation, by molecular oxygen, of the endogenous phenolic compounds, such as chlorogenic acid and tyrosine, to quinones. Subsequently, these quinones polymerize, causing the appearance of generally brown or black pigments. Oxygen, the phenolic compounds and the enzyme are therefore the three essential factors necessary for the manifestation of browning. This phenomenon is nevertheless only triggered after cellular decompartmentalization leading to contact between the (vacuolar) phenolic substrates and the (cytoplasmic) enzymatic system.

Some fruits, such as kiwi, do not have a tendency to brown because they have few or no substrates. Oranges do not brown because of the low enzymatic activity at the PH of these fruits.

In potatoes, considerable enzymatic browning is observed if the surfaces of the vegetable are exposed to oxygen before cooking. Enzymatic alteration is also observed in damaged or diseased tubers. Polyphenol oxidas s, in particular phenolas s, are the main constituents of the nzymatic system responsible for the alteration of ph nolic substrates into quinones or other components which can react with amino acids in a mann r similar to sugars to produce products of the Maillard reaction.

Chlorogenic acid is a potent antioxidant used in the food industry, with the exception of the potato processing industries.

It is indeed known that potatoes are highly sensitive to browning after cooking. This pigmentation is due to the formation of a complex between the ferric ions (Fe³⁺) and chlorogenic acid and/or caffeic acid, a product of hydrolysis of chlorogenic acid. In freshly cooked potatoes, a colourless ferrous iron (Fe2+)-chlorogenic acid complex forms before being subsequently oxidized in the air to a coloured ferric iron-chlorogenic acid complex.

Because of the high iron content of potatoes, the use of chlorogenic acid for preventing browning of potatoes has never been envisaged.

The authors of the present invention have now found, unexpectedly, that chlorogenic acid can be used to prevent or inhibit the browning of potatoes after cooking.

Without wishing to be bound by a precise mechanism, they observed that introduction of chlorogenic acid, in particular in the form of a cold emulsion, at the time of passage through a potato masher makes it possible to protect the potatoes from oxidation at the time of the final drying phase.

The invention therefore relates to the use of chlorogenic acid for preventing or inhibiting browning reactions in potatoes after cooking. Preferably, chlorogenic acid is used during the manufacture of dehydrated potato flakes, in particular during passage through the potato masher. The pressing stage is an operation carried out at about 96° C., a temperature at which the enzymes, such as polyphenol oxidases, which are capable of converting chlorogenic acid to quinones are denatured. Moreover, pressing is a very quick operation (about three minutes). The complexing of chlorogenic acid and then the oxidation of the complex formed would therefore not have time to occur. Chlorogenic acid also plays an antioxidant role during the final drying phase, before packaging of th dehydrated potato flakes und r nitrogen. Preferably, chlorogenic acid is us d in combination with lecithin, in the form of a cold mulsion, as explained below.

The invention thus provides a method for preventing or inhibiting browning reactions in potatoes, in particular in the manufacture of dehydrated potato flakes, which method comprises the step consisting of adding chlorogenic acid after cooking of the potatoes, whereby browning reactions are prevented or inhibited. Advantageously, chlorogenic acid is added before or during passage through the potato masher.

The invention also provides a method for the manufacture of dehydrated potato flakes, in which chlorogenic acid is added as antioxidant. In particular, the chlorogenic acid may be added to the potatoes after cooking, especially under conditions which make it possible to prevent the complexing of the chlorogenic acid with iron and/or the oxidation of the complexes thus formed.

These conditions consist in particular in using chlorogenic acid, free from iron and enzymes, such as polyphenol oxidases, which are implicated in chlorogenic acid oxydation.

These conditions also consist in using chlorogenic acid in the form of a cold emulsion.

More generally, chlorogenic acid is advantageously added in the form of a cold solution, i.e. at room temperature, for instance at a temperature between 15 and 25° C., so as to avoid denaturation thereof.

Preferably, chlorogenic acid is added in the form of a cold emulsion together with additive usually used in food industry, for instance an emulsifying agent such as lecithin. Indeed, the inventors demonstrated that combining chlorogenic acid with lecithin makes it possible to potentiate the antioxidant effect of chlorogenic acid. In addition to its emulsifying properties, lecithin also have antioxidant properties. Lecithin could thus prevent, chlorogenic acid from being oxidized in the course of the manufacturing process. A lecithin of any origin (soybean, sunflower, canola seeds, etc . . . ) is appropriate to carry out the invention.

In addition, as described above, the pressing operation in order to form th mashed potato is very quick. The usual duration of this op ration is about 3 minutes.

As used herein the term “cold emulsion” denotes an emulsion at room temperature which comprises chlorogenic acid together with additives, i.e. emulsifiers, antioxidants, etc . . . , that are usually added to the cooked potatoes in the potato masher. It is actually an advantage of the invention that chlorogenic acid be water soluble at room temperature. Accordingly the emulsion does not require warming prior to adding to the cooked potatoes. However the invention should not be bound to this embodiment and chlorogenic acid may be added in any suitable means that the skilled in the art can readily determine.

A method according to the invention comprises the steps consisting in:

cleaning and peeling the potatoes,

slicing and/or blanching and cooling the said potatoes,

cooking the washed, sliced and/or blanched potatoes so as to allow passage through a potato masher,

putting the potatoes thus cooked through the potato masher, and

dehydrating and processing the mashed potato thus obtained into flakes;

in which chlorogenic acid is added between the cooking step and the step for passing through the potato masher.

Preferably, the chlorogenic acid is obtained from cutting potato and/or blanching waters and/or from molasses and/or from scraped mashed potato which are by-products derived from the method for manufacturing dehydrated potato flakes. It may also be synthetic chlorogenic acid or chlorogenic acid extracted from other plants.

The expression “molasses” denotes the waste in the form of a viscous pulp obtained by brushing the potatoes after steam peeling. The molasses contain a mixture of potato skin, and cooked and raw starch.

The expression “scraped mashed potato” is understood to mean the dried mashed potato recovered on the satellites with which all potato drying cylinders are equipped.

The chlorgenic acid is advantageously added in a proportion of between 0.01% and 0.1% relative to the weight of potato dry matter. Preferably, chlorogenic acid is add d in combination with lecithin. Advantageously, chlorogenic acid and lecithin are added as a cold emulsion comprising, in weight relative to the weight of potato dry matter, lecithin 1% to 10%, preferably 3% to 5%, and chlorogenic acid 0.01% and 0.1%. This emulsifying and antioxidant composition may further comprise, in weight relative to the weight of potato dry matter, at least 0.05%, preferably 0.1% to 0.2%, of a glycolipid derived from a vegetal, in particular a di/trigalactoglycerid, as described in the French patent application FR 0202492.

The present invention therefore also relates to the dehydrated potato flakes which can be obtained by a method described above.

The invention further relates to an emulsifying composition that comprises, in weight relative to the weight of potato dry matter, lecithin 1% to 10%, preferably 3% to 5%; chlorogenic acid 0.01% and 0.1% and optionally at least 0.05%, preferably 0.1% to 0.2%, of a glycolipid derived from a vegetal, in particular a di/trigalactoglycerid.

The invention proposes, in addition, a method for preparing chlorogenic acid from potato cutting and/or blanching waters and/or from molasses and/or from scraped mashed potato. Such a method is particularly advantageous since it constitutes an enhancement of the value of the waste waters and by-products derived from the processing of potatoes, and since it makes it possible, in addition, to provide chlorogenic acid with a minimum purity of 90% this being although commercial chlorogenic acid is extremely expensive and furthermore partially oxidized.

The method for preparing chlorogenic acid according to the invention comprises the step consisting in adsorbing chlorogenic acid onto a solid support which does not retain the minerals, and more generally cations. An appropriate solid support is for example polyvinylpyrrolidone (pvp). Where chlorogenic acid is prepared from molasses or scraped mashed potato, water is added to said molasses or scraped mashed potato prior to adsorbing on a solid support so as to solubilize chlorogenic acid.

This step makes it possible to separat chlorogenic acid from the min rals and enzymes which are associated with it, as w ll as from iron that is present in high amount in potatoes. Thus th chlorog nic acid so prepared is free from iron and enzymes, such as polyphenol oxidases, two elements that are implicated in chlorogenic acid oxydation and in browning reactions in potatoes.

The chlorogenic acid so adsorbed may further be recovered according to appropriate means well known by the skilled in the art. Other examples of solid support appropriate to carry out the invention are well known to the skilled in the art.

### EXAMPLE 1

### Use of Chlorogenic Acid as Antioxidant in a Method for Preparing Dehydrated Potato Flakes

Chlorogenic acid is added to the solution for emulsifying which is introduced into the potato mashing device in an amount of 0.01% to 0.1% by weight relative to the weight of dry matter.

There are then added 18 to 25 kg of molten glyceryl monostearate, about 4 kg of sodium hydrogen pyrophosphate, 0.5 to 2 kg of citric acid and 0.5 to 2 kg of metabisulphite dissolved in 3 to 5 l of water, and ascorbic acid and an antioxidant such as BHA. The mixture is then stirred for 2 minutes.

The mixed ingredients are pumped into the potato mashing cylinder at a flow rate of 30 l/h for a small cylinder (1 000 kg/h of peeled potatoes corresponding to 180 kg/h of dehydrated flakes) or 90 l/h for a large cylinder (3 500 kg/h of peeled potatoes corresponding to 660 kg/h of dehydrated flakes), while continuing to stir gently.

### EXAMPLE 2

### Purification of Chlorogenic Acid from Potato Cutting Waters or Blanching Waters

The methods for preparing dehydrated potato flakes involve blanching of sliced potatoes, prior to their being cooked. This step of washing with hot water at 80° C. generates waste waters, or blanching waters, which contain mainly starch, amylos and amylopectin, and chlorog nic acid (about 2% of th dry xtract of th se blanching waters).

The waste waters produced at the time of the potato slicing/washing step (“cutting waters”), during the production of dehydrated potato flakes or of other products derived from potatoes such as crisps, can also be upgrad d as a source of chlorogenic acid.

The chlorogenic acid may be purified from these cutting or blanching waters by adsorption on polyvinylpyrrolidone (PVP).

The chlorogenic acid is attached, by adsorption to PVP, in its water-insoluble form (pvp or POLYCLAR AT (GAF Corporation, Linden, N.J.)).

The polyvinylpyrrolidone is provided in the form of a polymer possessing electrophilic and nucleophilic sites, which is capable of forming bonds with numerous constituents and in particular with the phenolic compounds. The latter are adsorbed with various mechanisms according to their structure and their degree of condensation.

The hydrogen bond between a phenolic proton and the oxygen of the carbonyl group of pyrrolidone appears as the main mechanism allowing the adsorption. For their study, the authors of the invention used previously purified PVP in order to remove the fine particles and the metal ions. The fractionation is carried out by percolation in a column. The PVP is mixed at 50% with CELITE (diatomaceous earth product) in order to facilitate the flow. During the passage of the cutting waters, the phenolic compounds are completely adsorbed; the salts, the sugars and the organic acids are not retained. Percolation of water, makes it possible to wash the resin completely; there is then no longer only a “PVP-chlorogenic acid” complex in the column.

To selectively desorb the chlorogenic acid, various aqueous-alcoholic solvents may be used. The most suitable solvent consists of ethanol-water-hydrochloric acid (70-30-1) mixture. It allows good desorption. To recover the phenolic compounds still attached to the resin, decinormal sodium hydroxide may be used. The chlorogenic acid solution obtained is first neutralized to pH 7, and then concentrated under vacuum in order to obtain a concentrated chlorogenic acid solution. The chlorogenic acid is then purified by recrystallization from hot water and crystallized at 4° C. The chlorogenic acid crystals are dried in an oven under vacuum in order to obtain chlorogenic acid in powdered form. If the purity of th manufactured chlorogenic acid is inad quate, a second recrystallization from hot water makes it possible to obtain the desired purity.

The chlorogenic acid thus obtained is in the form of a white powder of low odour, having a dry extract of 92±4% and a minimum purity of 90% (HPLC analysis). The chlorogenic acid is soluble at 4% in water at 20° C. It is also soluble in alcohol but only slightly soluble in oils. The pH of a 1% chlorogenic acid solution in water is 5.0.

1. A method for preventing or inhibiting browning reactions in potatoes which method comprises the step consisting of adding chlorogenic acid after cooking of the potatoes, whereby browning reactions are prevented or inhibited.

2. The method according to claim 1, for preventing or inhibiting browning reactions during the manufacture of dehydrated potato flakes.

3. The method according to claim 1 or 2, wherein chlorogenic acid is added in combination with lecithin.

4. A Method for the manufacture of dehydrated potato flakes, comprises the steps consisting of:
cleaning and peeling the potatoes,
slicing and/or blanching and cooling the said potatoes,
cooking the washed, sliced and/or blanched potatoes so as to allow passage through a potato masher,
putting the potatoes thus cooked through the potato masher, and
dehydrating and processing the mashed potato thus obtained into flakes;
in which chlorogenic acid is added between the cooking step and the step for passing through the potato masher.

5. The method according to claim 4, in which the chlorogenic acid is added in a proportion of between 0.01% and 0.1% relative to the weight of potato dry matter.

6. The method according to claim 4 or 5, in which chlorogenic acid is added in combination with lecithin.

7. The method according to any one of claims 4 to 6, in which the chlorogenic acid is obtained from potato cutting and/or blanching waters and/or from molasses and/or from scraped mashed potato.

8. Dehydrated potato flake which can be obtained by the method of any one of claims 4 to 7.

9. Method for preparing chlorog nic acid from potato cutting and/or blanching waters and/or from molasses and/or from scraped mashed potato comprising the step consisting in adsorbing chlorog nic acid onto a solid support which does not retain cations and recovering the chlorogenic acid so adsorbed.

10. An emulsifying composition that comprises, in weight relative to the weight of potato dry matter, lecithin 1% to 10%, chlorogenic acid 0.01% and 0.1%; and optionally at least 0.05% di/trigalactoglycerid.
